(19) United States
(12) Patent Application Publication
(10) Pub. No.: US 2022/0196512 A1
(43) Pub. Date: Jun. 23, 2022

(54) DETECTION OF A LEAKAGE IN A SUPPLY GRID

(71) Applicant: Siemens Aktiengesellschaft, München (DE)

(72) Inventors: Moritz Allmaras, München (DE); Jan Christoph Wehrstedt, München (DE); Utz Wever, Starnberg (DE)

(21) Appl. No.: 17/433,157

(22) PCT Filed: Feb. 18, 2020
(86) PCT No.: PCT/EP2020/054161

§ 371 Date: Aug. 23, 2021

(30) Foreign Application Priority Data
Feb. 25, 2019 (EP) 19159114.8

(51) Int. Cl. G01M 3/28; G06Q 50/06; G06K 9/62

(52) U.S. Cl. CPC G01M 3/2807; G06N 20/00; G06K 9/6247; G06Q 50/06

(57) ABSTRACT

A method for detecting a leakage of fluid in a supply grid is disclosed. The method includes measuring a flow of the fluid at first locations by first sensors; predicting a flow at a second location by a self-learning system based on the measured flows, wherein the self-learning system has been trained to predict the flow at a specified location in a supply grid; measuring an actual flow of the fluid at the second location by a second sensor located at the second location; ascertaining a difference between the actual flow measured at the second location and the flow at the second location predicted by the trained system; and outputting a notification of an assumed leakage when the ascertained difference is greater than a specified threshold. Devices and assemblies for detecting a leakage of fluid in a supply grid are also disclosed.

The present patent document is a § 371 nationalization of PCT Application Serial No. PCT/EP2020/054161, filed Feb. 18, 2020, designating the United States, which is hereby incorporated by reference, and this patent document also claims the benefit of European Patent Application No. 19159114.8, filed Feb. 25, 2019, which is also hereby incorporated by reference.

### TECHNICAL FIELD

The disclosure relates to the detection of a leak of fluid in a supply network. Exemplary applications are the identification of a leak in a drinking water or wastewater network or in a gas or district heating supply network.

### BACKGROUND

Embodiments are described below with reference to drinking water supply networks. However, the disclosure is not restricted to use in drinking water supply networks. Rather, it may also be used in wastewater networks, gas supply networks, or district heating supply networks.

Nowadays, in the 21st century, drinking water is an important resource throughout the world. Most forecasts assume that the importance of drinking water will even increase in the medium and long term. Consequently, it may be expected that responsible and economical use of drinking water will become more and more important.

In this context, it is necessary to avoid leaks, that is to say the unintentional and undesirable escape of drinking water from the lines of the water network, as far as possible. However, complete avoidance, that is to say complete tightness of the network, may not be possible. Empirically, in Germany, water losses in the single-digit percentage range result on account of leaks in the drinking water supply network; in other countries, the losses are sometimes also considerably above this.

An underlying problem may therefore be how to identify whether there is a leak in the supply network under consideration. Identifying that there is a leak is also referred to as “detection” or “detecting” of a leak within the scope of this patent application. “Detection” or “detecting” does not necessarily include in this case locating/localization of the leak. However, as will be shown, the present disclosure in some embodiments cannot only determine the fundamental presence of a leak (somewhere) in the supply network, but rather may even locate the leak more or less accurately.

The prior art already contains a number of approaches to detecting a leak of a fluid in a supply network.

A first well-known approach is to set up a mass balance. In this case, a delimitable region of the network having a single inflow or a small number of inflows is expediently considered. Such a delimited region of the network is also referred to as a “District Metering Area” (DMA) in technical language. In addition to the inflow(s), a DMA has a number of consumers and optionally one or more outflows. In order to set up the mass balance, the inflows into the DMA are compared with the sum of the “outflows” for the consumers and possibly the outflows from the DMA as a whole. If the inflows correspond to the outflows determined in this way, the network is “tight”; there are therefore no leaks. In contrast, if the sum of the inflows is significantly greater than the sum of the outflows, including the consumptions, one or more leaks in the network may be assumed.

One problem with the mass balance method is the large amount of effort which must be used because the exact consumption of each individual consumer must be determined for a particular period. A further problem is of a data protection nature. The legal situation in many countries does not allow the water consumption of all consumers in a DMA to be captured and recorded in a timely manner at all, for example.

A second well-known approach to detecting leaks in a network involves so-called “night flow analysis”. In this case too, a delimitable region of the network, that is to say a DMA, may be considered. During night flow analysis, the inflow into the DMA is captured over a low-consumption period, for example, between 2 a.m. and 4 a.m. Smaller measurement intervals in the region of a few minutes are also possible. The entire inflow in the same period is determined over many days or weeks. This time series is analyzed for an increase in the water consumption as an indicator of a new leak using statistical methods. In the simplest case, the inflow is observed over time and a leak is inferred in the event of an increase in the inflow.

One disadvantage of night flow analysis is that only new leaks which arise after the start of the measurements are captured. A further disadvantage is that special events, (e.g., sporting events), which, through broadcast on the television or alternative media (Internet), provide an unusually high water consumption in the measurement period, may be incorrectly interpreted as an indication of a leak. Finally, major changes in the topology of the network, (e.g., the purchase of one or more apartment buildings or the activation of an installation in a business that is active in the (night-time) measurement period), may also result in an increase in the consumption which is incorrectly interpreted as a newly arisen leak in the network.

A disadvantage of both approaches mentioned—mass balance and night flow analysis—is also the fact that these methods may only identify that there is a leak (somewhere) in the network, but not where this leak is present within the network. The leak must therefore be located using other, additional methods.

A third approach to detecting leaks in a network, which is known to a person skilled in the art, involves measuring the flow rates at a plurality of locations in the network and then comparing the measured values with simulated values which were obtained by a hydraulic (in the case of a water network) simulation of the network. The topology of the network, that is to say the arrangement of the lines (pipes), and the locations and type of each consumer connected to the supply network may be required as input data for the hydraulic simulation. Because, on account of the considerable effort and data protection concerns described above, it is not possible to take into account the actual consumptions of the consumers, equivalent consumption profiles are also required for the different types of consumers present in the network. An equivalent consumption profile is understood as meaning a fictitious, representative consumption profile of a particular consumer type (e.g., apartment, house, small business). On the basis of the topology of the network, the consumers connected to the latter and the equivalent consumption profiles used, the time-dependent flow rate of the water through the line may be calculated for each point in the network by a hydraulic simulation. If the actual flow rates measured by the available sensors differ significantly from the calculated values, a leak in the network is inferred. If the network has a multiplicity of sensors, the location of the leak may be narrowed down and at least roughly located by evaluating all sensors.

A challenge of the approach described is to carry out the hydraulic simulation correctly and with a reasonable amount of effort. This becomes more difficult, the larger and more complex the considered part of the network is. In addition, both the topology with respect to the course and nature of the lines and the existence and characterization of the consumers must be relatively well known.

### SUMMARY AND DESCRIPTION

The aim of the present disclosure is to develop an alternative method for detecting a leak in a supply network, which may reliably identify and locate a leak, in particular, even in relatively large and complex networks.

The scope of the present disclosure is defined solely by the appended claims and is not affected to any degree by the statements within this summary. The present embodiments may obviate one or more of the drawbacks or limitations in the related art.

A method, (e.g., an automated method), for detecting a leak of fluid in a supply network is proposed, wherein the supply network has pipes through which the fluid flows, first sensors for measuring the flow rates of the fluid at first locations in the supply network, and at least one second sensor for measuring the flow rate of the fluid at a second location in the supply network. In this case, the method includes: measuring the flow rates of the fluid at the first locations by the first sensors; predicting the flow rate at the second location by a self-learning system based on values of the measured flow rates at the first locations, wherein the self-learning system was trained to predict the flow rate at a predefined location in the supply network; measuring the actual flow rate of the fluid at the second location by the second sensor at the second location; determining the difference between the actual flow rate measured at the second location and the flow rate at the second location predicted by the trained system; and outputting a message of a suspected leak if the determined difference is greater than a predefined limit value.

As disclosed herein, a self-learning system may be advantageously used to detect a leak in a supply network. In a first phase, the self-learning system is trained to be able to predict the flow rate at a predefined location of the supply network. After the training phase, the trained system is used during operation of the supply network. For this purpose, the trained system predicts the flow rate at a particular location in the supply network on the basis of flow rates actually measured during operation. The concept is that the predicted value correctly indicates the expected flow rate. The flow rate is now actually measured at the particular location for which the flow rate value was predicted. If the predicted value corresponds to the actually measured value, a “stable” and “tight” supply network is inferred. In particular, the conclusion is drawn therefrom that, after the training phase of the self-learning system has been completed, no leaks have arisen in the environment of the analyzed location in the network. In contrast, if the difference between the predicted flow rate value and the actually measured flow rate value exceeds a certain threshold, that is to say a predefined limit value, a message is output. The exceeding of the limit value may be interpreted as an indication of a newly arisen leak in the supply network.

An advantage of the method is the speed with which it may be determined whether or not there are anomalies in the supply network. This is due to the fact that the trained system may very quickly predict the flow rate at the relevant location because the trained system does not carry out any analytical or model-based calculations or would not have to resort to such calculations for this purpose. Rather, the self-learning system has simply learnt during the learning phase what flow rate may be expected for which input data and, during operation, only infers the flow rate value at the corresponding location according to trained laws based on the given input data, e.g., the measured flow rates.

It may be possible to predict the flow rate only for that location for which the self-learning system has also been trained. However, it is possible to train the self-learning system to predict the flow rate at a plurality of locations of the supply network. The number of measurement points in the network may not necessarily be greater than those locations whose flow rates are predicted.

The described method may be applied to any type of supply network in which a leak of a fluid is to be detected. A fluid is understood as meaning any type of liquid or gas. If the fluid is water, the supply network may be a drinking water supply network or a wastewater network. If the fluid is natural gas, the supply network may be a gas supply network. If the supply network is a district heating supply network, the transfer medium, (e.g., the fluid), may be hot water or also steam.

The supply network includes a number of pipes which are also referred to as pipelines or only as lines. The pipes are there to guide the fluid to the consumers and possibly away from them again. The pipes are therefore configured to have the fluid flow through them.

As disclosed herein, the flow rate at a particular location in the supply network is understood as meaning the volume of fluid which flows through the cross section of the pipe at the corresponding location for each period of time. In this case, the cross section of the pipe is defined by its internal diameter. The flow rate is also referred to as the “volumetric flow rate”. It has the SI unit m³/h. The flow rate is therefore used to mean a value which characterizes and quantifies the flow rate. It may consequently also be referred to as a “flow rate value”.

The flow rate is measured using flowmeters. A flowmeter may have two main components: the actual measurement sensor, which is used as a flow rate sensor; and an evaluation and supply part, which is also referred to as a transmitter or measurement transducer. As disclosed here, the flowmeters are also referred to as a “sensor”.

The self-learning system may be in the form of an artificial neural network. It has artificial neurons which are on one or more layers and are connected to one another. An artificial neuron may process a plurality of inputs and may react accordingly via its activation. For this purpose, the inputs are transferred, in a weighted form, to an output function which calculates the neuron activation. The weightings are continuously adapted during the training phase of the self-learning system until the output for a particular input corresponds as accurately as possible to a target value.

A person skilled in the art knows how to configure a suitable self-learning system. An example of a suitable programming framework is TensorFlow. TensorFlow is a programming framework for data-stream-oriented programming. It is used, for example, from Python programs and is implemented in Python and C++. TensorFlow is popular, in particular, for self-learning systems in the field of machine learning. TensorFlow was originally developed by the Google Brain team for Google's internal needs and was later published under the Apache 2.0 open source license. In research and production operation, TensorFlow is currently used by different teams in commercial Google products such as voice recognition, Gmail, Google Photos and Google Search. The map service Maps is also improved by analyzing the photos which are recorded by Street View and are analyzed with the aid of artificial intelligence based on TensorFlow. Many of these products previously used the predecessor software DistBelief.

The training of the self-learning system includes the following acts.

In act i), the respective flow rate is measured at a plurality of first locations in the supply network by flowmeters which are also referred to as sensors within the scope of this patent application and one of which may be situated at each first location (also: measurement location). The set of measured flow rates at the different first locations forms the input data for the self-learning system.

In act ii), the self-learning system, (e.g., the artificial neural network), determines an output value on the basis of the input data collected in act i). In the present case, the output value is specifically the flow rate, that is to say the flow rate value, at the corresponding location, the so-called second location.

In act iii), the flow rate at the second location determined by the self-learning system is compared with a target value, and, in act iv), the self-learning system is adapted taking into account the comparison used in the previous act. The learning method, which is used to train the self-learning system to correctly predict the flow rate at a particular location, is in the form of supervised learning. In supervised learning, the artificial neural network is provided with an input pattern and the output produced by the neural network in its current state is compared with the value which is actually intended to be output by the neural network. The changes to be made to the network configuration may be inferred by comparing the desired output and the actual output. The delta rule (also perceptron learning rule) may be used in the case of single-layer neural networks. Multi-layer neural networks may be trained using error back propagation, which is a generalization of the delta rule.

In a first alternative, the target value includes an actually measured flow rate at that location at which the self-learning system has to predict the flow rate. In other words, the flow rate at the second location predicted by the self-learning system is compared with the actually present flow rate measured by a corresponding sensor.

This selection of the target value has the advantage that the target value may be obtained quickly and precisely. The target value may be obtained quickly because it is only necessary to measure the flow rate using a corresponding sensor for this purpose. The target value measured by a sensor is highly precise, depending on the grade and quality of the sensor, because it is measured directly, and any error sources are therefore minimal.

In a second alternative, the target value is not directly measured, but rather is determined by a simulation. The flow rate at a particular location predicted by the self-learning system is therefore compared with a flow rate at the location calculated by a simulation. The quality of the simulation is a decisive condition for the training phase being successful and, in particular, for the trained system being able to be successfully used during operation. Because the flow rates which are calculated by the simulation are used as target values when training the self-learning system, the simulated flow rates may reflect reality with a high degree of reliability and precision. In other words, it is trusted that the simulation is able to exactly calculate the actual flow rate value for the wide variety of input data.

The advantage of a target value calculated analytically or in a model-based manner is that there is no need for a sensor and no need for a flow rate measurement at the corresponding location during the training phase. However, during operation, a sensor and a flow rate measurement are unavoidable because, during operation, the flow rate predicted by the trained system is compared with the actually present flow rate and the latter is determined by an actual measurement at the corresponding location.

If the fluid is water, the simulation is also referred to as a hydraulic simulation.

The simulation may be more precise, the more numerous and more precise its input, that is to say its input data. The topology of the network, for example, is possible as input data for a supply network. The topology is understood as meaning the arrangement and nature of the pipes, including the placement of the nodes, at which three or more pipes meet. Further input data needed are the locations at which consumers connected to the supply network are placed as well as the type of consumers. Further input data needed for a precise simulation or are at least of great benefit are properties of the pipes, for example, their diameters or their flow resistances. Finally, any type of equivalent consumption profiles for the different types of consumers are required. Because the actual consumptions of the consumers cannot be taken as an input for practical and data protection reasons, the simulation may be based on representative consumptions, so-called equivalent consumption profiles. For example, it is possible to use an equivalent consumption profile for each of a house, an apartment building (with an indication of the apartment units), a small business, a hospital, etc.

The target values for the corresponding input data are advantageously quickly provided during the training phase because this makes it possible to minimize the duration of the training phase. For this purpose, it may be advantageous to reduce the input data of the simulation before determining the target value. This may be carried out by a series expansion, for example. Corresponding techniques and procedures for this are known to a person skilled in the art; principal component analysis is mentioned merely by way of example in this context.

If the topology of the network changes significantly, for instance as a result of significant changes in the consumers or as a result of changes in the laid pipes, the self-learning system is retrained. However, the self-learning system may pre-allocate the parameters, (e.g., weightings), of the previous trained system, with the result that only a relatively fast and uncomplicated update of the parameters, that is to say a shortened training phase, may be necessary.

Returning to the method for training the self-learning system: acts i) to iv) are repeated until a predefined abort criterion is reached. The abort criterion may involve the difference between the flow rate at a particular location determined by the self-learning system and the “true” flow rate at this location—that is to say the target value—being less than a predefined threshold value. In other words, both values are intended to correspond or to differ only insignificantly. In order to provide that the self-learning system is robust and reliably predicts the true flow rate at the corresponding location over a wide range of input data, the abort criterion may also include the average over a predetermined number of iterations falling below the predefined threshold value for the difference.

If the abort criterion has been satisfied, the self-learning system is not changed any further. In the case of an artificial neural network, the weightings are not adapted any further to the artificial neurons, but rather are retained, for example.

The training phase is followed by the operation of the trained system, which may also be referred to as a use phase.

In act a) of the use phase, the flow rates of the fluid through the pipes at the first locations in the supply network are measured. This needs to take place substantially at the same locations as during the training phase. The reason for this is that a trained system has been trained for flow rates measured at the first locations, with the result that it may also be used in the use phase only with input data from these first locations. Broadly speaking, a self-learning network may not be trained to recognize apples, but may be used to recognize pears.

The flow rates are advantageously determined during operation using the same first sensors which were used to feed the self-learning system with input data in the training phase.

In act b), the trained system predicts the flow rate at the second location on the basis of the specifically measured flow rates at the first locations. If the self-learning system was trained thoroughly and comprehensively during the training phase, there is the not unjustified expectation that the predicted flow rate for the second location will correspond to reality.

In order to check this, the actual flow rate at the second location is measured by a sensor in act c). If the target value is already determined by measurement instead of by simulation during the training phase, the same sensor which measured the flow rate at the second location during the training phase may be advantageously used to measure the flow rate at the second location during the use phase.

In act d), the difference between the flow rate predicted by the trained system and the flow rate measured by the second sensor is determined. The subtraction of one value from the other may be computer-implemented or may be implemented using control technology.

In act e), a message is output if the difference exceeds a predefined limit value. In other words, a warning is output if the prediction does not correspond to the measurement for the flow rate or the two values differ significantly from one another. If the prediction of the trained system which is correct per se is assumed, a significant difference between the prediction and the measurement is a clear indication that, (assuming that the topology of the supply network per se has remained unchanged because the training phase), a leak has arisen in the supply network after the completion of the training phase. It may also be inferred that the leak is at least in the environment of the second location or at least has a measurable influence on it.

The first sensors are advantageously placed in the supply network in such a manner that their measured values do not correlate with one another. Although it may not be harmful per se if the measured flow rate values from a first sensor correlate with the flow rate values of another first sensor in the supply network, the sensors have maximum effectiveness if their measured values do not correlate with one another. There is no universal rule for avoiding correlation of two adjacent sensors. Rather, a person skilled in the art advantageously selects the placement of the first sensors in the specific individual case in such a manner that they do not correlate with one another.

In one embodiment, not only is a single “second location” in the supply network analyzed with respect to a potential leak, but rather the method is carried out for a plurality of second locations. For this purpose, it is again important for the self-learning network to already be trained for the plurality of second locations in the training phase. Only then may the trained network reliably predict the respective flow rates at the plurality of second locations during operation.

In a further embodiment, the supply network has n+m sensors, specifically n first sensors and m second sensors. In a first part of the method, the self-learning system is trained using the n first sensors in such a manner that it correctly predicts the flow rates at the m second sensors. In a second part of the method, the self-learning system is then trained, on the basis of measured flow rates of the m sensors which now act as first sensors, to predict the flow rates of the n second sensors acting at second locations. The training phase is therefore concluded, and the use phase follows. Here, the supply network is first of all analyzed for leaks at them locations of them second sensors. The roles are then swapped, that is to say the n formerly first sensors now act as second sensors and the supply network is analyzed for leaks at the n locations of the now n second sensors.

An advantage of this method is that more locations of the supply network may be analyzed for anomalies, e.g., leaks. Apart from the n+m sensors mentioned, the supply network may have further sensors which act as first sensors in both training phases and thereby make the self-learning system more robust.

The disclosure does not only relate to a method for detecting a leak of fluid in a supply network, but also relates to a corresponding apparatus. Specifically, the disclosure relates to an apparatus for detecting a leak of fluid in a supply network having pipes configured for having a fluid flow through them, first sensors for measuring the flow rates of the fluid at first locations in the supply network, and at least one second sensor for measuring the flow rate of the fluid at a second location in the supply network. The apparatus includes: a self-learning system which was trained to predict the flow rate at a predefined location in the supply network; a first capture unit for capturing the flow rates of the fluid at the first locations in the supply network, as measured by the first sensors; a prediction unit for predicting the flow rate at the second location by the trained system on the basis of the values of the flow rates at the first locations, as captured by the first capture unit; a second capture unit for capturing the actual flow rate of the fluid at the second location by the second sensor at the second location; a determination unit for determining the difference between the actual flow rate measured at the second location and the flow rate at the second location predicted by the trained system; and an output unit for outputting a message of a suspected leak if the determined difference is greater than a predefined limit value.

Special designs and variations of the disclosure described in connection with the method for detecting a leak may be accordingly applied to the apparatus.

Finally, the disclosure also relates to an arrangement that includes the following components: a supply network having pipes which are suitable for having a fluid flow through them, first sensors for measuring the flow rates of the fluid at first locations in the supply network, and at least one second sensor for measuring the flow rate of the fluid at a second location in the supply network; and an apparatus for detecting a leak of the fluid, as disclosed above.

### BRIEF DESCRIPTION OF THE DRAWINGS

The disclosure is described below based on the exemplary embodiments with reference to the attached drawings, in which:

FIG. 1 illustrates an example of a supply network connected to a plurality of different consumers.

FIG. 2 illustrates a first exemplary embodiment of an apparatus for detecting a leak of fluid in a supply network.

FIG. 3 illustrates a second exemplary embodiment of an apparatus for detecting a leak of fluid in a supply network.

### DETAILED DESCRIPTION

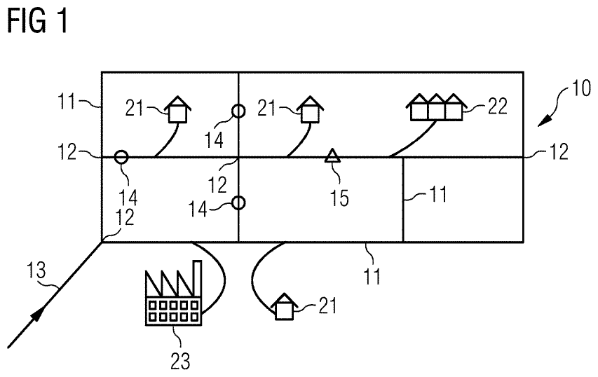

FIG. 1 illustrates, by way of example and schematically, a supply network 10 for supplying a number of consumers with drinking water. It is therefore a drinking water supply network. The disclosure is not restricted to drinking water supply networks, but rather may likewise be applied to other types of supply networks.

FIG. 1 shows a District Metering Area (DMA) which is part of a superordinate drinking water supply network. The supply network 10 shown in FIG. 1 has only a single inflow 13 and no outflows. The supply network 10 includes a number of pipes 11, wherein three or four pipes 11 respectively meet at a plurality of nodes 12 of the supply network 10. For better clarity, not all pipes 11 and nodes 12 present are referenced using reference signs in FIG. 1.

FIG. 1 also shows, by way of example, some consumers connected to the drinking water supply network 10. The consumers are divided into different categories; a plurality of houses 21, an apartment building 22, and a factory 23 are shown, by way of example, in FIG. 1. In reality, at least several dozen consumers, several hundred consumers, or several thousand consumers may be connected to a supply network in a DMA. For better clarity, only very few consumers connected to the supply network 10 are shown, by way of example, in FIG. 1.

For improved illustration of the disclosure, the topology of the supply network 10, (e.g., the number and branches of the pipes 11 and the number and type of consumers connected to the supply network 10), are therefore illustrated in a highly simplified manner in FIG. 1.

The supply network 10 shown does not have any (explicit) outflows. Nevertheless, an outflow of drinking water from the supply network 10 takes place by the consumers. However, the exact respective consumptions of the consumers are not known for practical and data protection reasons.

The supply network 10 also has three first sensors 14. These first sensors 14 are in the form of flowmeters and may measure the flow rate of the drinking water through the pipes 11 at the respective locations in the supply network 10 at which the first sensors 14 are situated. The locations at which the first sensors 14 are situated and for which the respective flow rate is measured are referred to as first locations.

The supply network 10 also has a further sensor referred to as a second sensor 15. The second sensor 15 is situated at a so-called second location in the supply network 10 and is able to measure the flow rate at this second location.

The object on which the disclosure is based is now to identify any leak in the supply network 10 during operation of the supply network 10. In other words, the intention is therefore to detect any leak in the supply network 10.

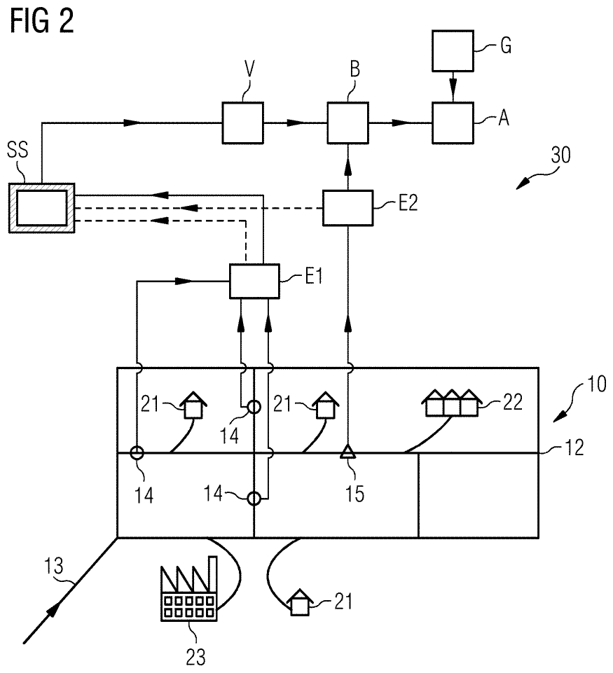

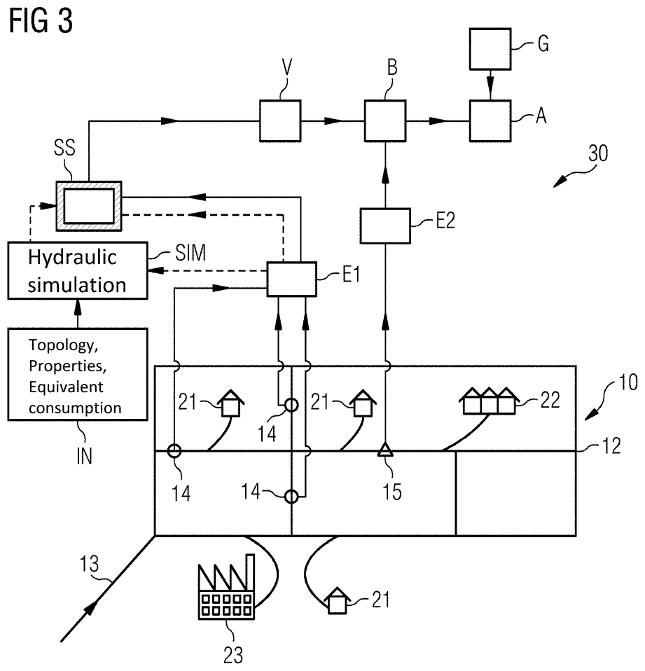

For this purpose, the disclosure uses a corresponding apparatus 30. A first exemplary embodiment of such an apparatus 30 for detecting a leak of fluid in a supply network 10 is shown in FIG. 2. In contrast, FIG. 3 shows a slightly modified exemplary embodiment of such an apparatus 30. The two exemplary embodiments differ substantially in the use of a different target value when training the self-learning system SS.

FIG. 2 first of all shows the same supply network 10 as that in FIG. 1. In order to avoid repetitions, reference is made to FIG. 1 for the description of the supply network 10 and of the consumers connected to the latter.

In addition to the supply network 10 and the consumers connected to the latter, FIG. 2 also shows an apparatus 30 for detecting a leak of fluid in the supply network 10. For this purpose, the three first sensors 14 are connected to a first capture unit E1. The first capture unit E1 is configured to capture and forward the flow rates measured by the first sensors 14. FIG. 2 also shows a second capture unit E2. In a similar manner to the first capture unit E1, this second capture unit is configured to capture the flow rate measured by the second sensor 15 at the second location in the supply network 10 and, as soon as required in the process, to forward it to a corresponding location.

During the training phase, the self-learning system SS is connected to the first capture unit E1 and to the second capture unit E2 in the first exemplary embodiment shown in FIG. 2. These connections are indicated as dashed lines in FIG. 1. The first capture unit E1 provides the input data, specifically the measured flow rates at the first locations in the supply network 10. On the basis of this, the task of the self-learning system SS is to predict or determine an (expected) flow rate at another location in the supply network. This other location is the second location which has already been mentioned, specifically the location at which the second sensor 15 is situated. At the beginning of the training phase, the flow rate at the second location determined by the self-learning system SS may not yet correspond to the actual flow rate at this location. In order to train, that is to say improve, the self-learning system SS, the concept of supervised learning is used. For this purpose, the flow rate value determined by the self-learning system SS is compared with a target value. In the present exemplary embodiment, this target value is the flow rate actually measured at the second location. The flow rate at this location is advantageously measured using the second sensor 15 which is needed anyway to carry out the method during operation of the supply network 10.

The flow rate measured by the second sensor 15 is captured by the second capture unit E2 and is forwarded to the self-learning system SS. The flow rate value measured by the second sensor 15 is then compared in the self-learning system with the previously determined/predicted value. If the correspondence is too low—which might be the norm, as indicated above, in particular at the beginning of training—new flow rate values are measured by the first sensors 14. For these new flow rate values, the self-learning system SS attempts to predict the actual flow rate value at the second location as correctly as possible.

It is advantageous if the flow rates measured by the first sensors 14 in the second run differ from the measured flow rates in the first run. This is because, if the measured flow rates at the first locations are very similar or even identical, the self-learning system SS will correctly predict the flow rate at the second location without any major problems in the second run on the basis of what has been learned from the first run. However, during operation, the self-learning system SS is able to correctly predict the flow rate at the second location for a wide variety of flow rates at the first locations.

The described acts of a run (or: iteration) are therefore: measuring the flow rates at the first locations; predicting or determining the flow rate at the second location; and comparing the predicted flow rate with the actually measured flow rate.

A sufficient number of runs are carried out to allow the predefined abort criterion to be satisfied. The abort criterion may involve the difference between the flow rate at the second location determined by the self-learning system SS and the actually present flow rate (e.g., measured by the second sensor 15 at the second location) in each case being less than 5%, less than 2%, or less than 1%, for ten successive runs.

It is advantageous to also link this abort criterion mentioned by way of example to a further condition, specifically the fact that the flow rates measured at the first locations cover a wide range of values for the ten successive runs, for example. This means that there is a difference of at least 100% between the smallest measured flow rate of each first sensor 14 and the largest measured flow rate of the same first sensor 14, for example. More complex requirements are naturally also conceivable in order to provide wide coverage of the first flow rates in different runs.

The training phase is followed by operation, also referred to as a use phase, of the supply network 10. In this case, the flow rates at the first locations in the supply network are measured again. This is carried out by the first sensors 14. The measured flow rate values are captured by the first capture unit E1 and are forwarded to the self-learning system SS which is also referred to as a “trained system” SS within the scope of this patent application after the completion of the training phase. The forwarding of the flow rates captured by the first capture unit E1 to the trained system is indicated in FIG. 1 with a solid line—in order to distinguish it from the dashed connection during the training phase.

On the basis of the measured flow rates at the first locations, the trained system SS now predicts the expected flow rate at the second location in the supply network 10. This prediction is made by a prediction unit V. The predicted flow rate value is then compared with the actually present flow rate value at the second location—the latter was measured using the second sensor 15 and was captured by the second capture unit E2. The comparison between the predicted flow rate value and the actually present flow rate value is carried out by the determination unit B. This is simply a subtraction of the smaller of the two values from the larger of the two values. The difference determined in this manner is then forwarded to an output unit. The latter outputs a message if the difference is greater than a predefined limit value G.

The output of a corresponding message is an indication to the operator of the supply network 10 that there is a leak in the supply network 10, in particular in the region of the second location at which the predicted flow rate differed from the measured flow rate. However, conditions for the validity of this conclusion are that the topology of the supply network and the number and type of consumers connected to the latter have not changed after the completion of the training phase and that the self-learning system SS was trained reliably and robustly.

If the supply network 10 has a plurality of second locations with second sensors 15 and if the predicted flow rates are compared with the measured flow rates at a plurality of second locations, the potential leak cannot only be identified but also located—within certain limits—on the basis of a difference between the predicted flow rate and the measured flow rate at precisely one second sensor (or at least a subset of second sensors). However, detailed localization using other methods is then necessary in most cases.

FIG. 3 shows a second exemplary embodiment of an apparatus 30 for detecting a leak of fluid in a supply network 10. It differs from the apparatus 30 of the first exemplary embodiment in terms of the training of the self-learning system SS.

Specifically, in the second exemplary embodiment, only the measured flow rates at the first locations are initially forwarded from the first capture unit E1 to the self-learning system SS during the training phase. The self-learning system again predicts or determines an expected flow rate at the second location in the supply network 10. However, this expected flow rate is not directly compared with the flow rate measured at the second location in act iii) of the method, but rather with a simulated flow rate at the second location. It is very important for successful training of the self-learning system SS that the simulated flow rate at the second location is trustworthy, that is to say correct, because it constitutes the target value used to train the self-learning system SS. If the target value does not correspond to reality, the trained system SS logically also cannot correctly represent or predict reality.

In the present case of a drinking water supply network, the simulation SIM is a hydraulic simulation. For this purpose, the flow rates and further parameters (e.g., pressures, flow velocities, etc.) in the supply network are simulated analytically or in a model-based manner on the basis of fluid mechanics. The challenge of a hydraulic simulation SIM may be the fact that it quickly becomes very complex even for supply networks with a relatively simple topology. In addition, a series of input data IN may be required for the hydraulic simulation SIM. These data include the topology, (e.g., the arrangement and course of the pipes 11 and nodes 12), the flow rate at the inflow 13 into the supply network 10, the arrangement and type of consumers, equivalent consumption profiles of the individual consumer types (e.g., typical or representative consumption profiles for the individual consumer types); properties of the pipes, (e.g., coefficients of friction or internal diameters).

Based on the measured flow rates at the first locations and the available input data IN, the hydraulic simulation SIM simulates the expected flow rate at the second location and passes it to the self-learning system SS. The simulated flow rate at the second location acts as a target value for the self-learning system SS and as a measure of how well the self-learning system SS has already been trained.

The use phase, or operation, of the supply network takes place in the second exemplary embodiment in an identical manner to the first exemplary embodiment, which is why reference is made to the description thereof above.

In summary, it may be stated that the disclosure provides a method, an apparatus, and an arrangement which may be used to identify and, under certain circumstances, also locate a leak of fluid in a supply network in a simple manner with the aid of a self-learning system.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

Although the disclosure has been illustrated and described in detail by the exemplary embodiments, the disclosure is not restricted by the examples disclosed and other variations may be derived therefrom by a person skilled in the art without departing from the protective scope of the disclosure.

1. A method for detecting a leak of fluid in a supply network, wherein the supply network has pipes through which the fluid is configured to flow, first sensors for measuring flow rates of the fluid at first locations in the supply network, and at least one second sensor for measuring a flow rate of the fluid at a second location in the supply network, the method comprising:
a) measuring the flow rates of the fluid at the first locations by the first sensors;
b) predicting the flow rate at the second location by a self-learning system based on values of the measured flow rates at the first locations, wherein the self-learning system has been trained to predict a flow rate at a predefined location in the supply network;
c) measuring an actual flow rate of the fluid at the second location by the second sensor at the second location;
d) determining a difference between the actual flow rate measured at the second location and the flow rate at the second location predicted by the trained system; and
e) outputting a message of a suspected leak when the determined difference is greater than a predefined limit value.

2. The method of claim 1, wherein the self-learning system has been trained by:
i) measuring flow rates of the fluid at the first locations in the supply network by the first sensors;
ii) determining a flow rate at the second location by the self-learning system based on values of the flow rates at the first locations measured in act i);
iii) determining a difference between the flow rate determined in act ii) and a target value;
iv) adapting the self-learning system taking into account the difference determined in act iii); and
v) repeating acts i) to iv) until a predefined abort criterion is achieved.

3. The method of claim 2, wherein the training of the self-learning system according to acts i) to v) and the detection of the leak according to acts a) to e) are carried out for a plurality of different second locations.

4. The method of claim 3, wherein steps acts i) to v) are repeated with the proviso that, instead of the first sensors at the first locations, the second sensors at the second locations are used and vice versa, and
wherein acts a) to e) are repeated with the proviso that, instead of the first sensors at the first locations, the second sensors at the second locations are used and vice versa.

5. The method of claim 2, wherein the abort criterion comprises an average difference between the flow rate at the second location determined in act ii) and the target value falling below a predefined threshold value.

6. The method of claim 2, wherein the target value is the flow rate of the fluid through the pipe at the second location as measured by the second sensor.

7. The method of claim 2, wherein the target value is determined by a simulation.

8. The method of claim 7, wherein the simulation uses, as input data, a topology of the supply network, locations and types of consumers, and an equivalent consumption profile for each consumer.

9. The method of claim 8, wherein the input data are reduced by a series expansion before determining the target value.

10. The method of claim 1, wherein the first sensors are positioned at the first locations in the supply network in particular, in such a manner that measured values of the first sensors do not correlate with one another.

11. The method of claim 1, wherein the fluid is water, and
wherein the supply network is a drinking water supply network or a wastewater network.

12. The method of claim 1, wherein the fluid is a gas, and
wherein the supply network is a gas or district heating supply network.

13. An apparatus for detecting a leak of fluid in a supply network having pipes configured for having a fluid flow through the pipes, first sensors for measuring flow rates of the fluid at first locations in the supply network, and at least one second sensor for measuring a flow rate of the fluid at a second location in the supply network, the apparatus comprising:
a self-learning system trained to predict a flow rate at a predefined location in the supply network;
a first capture unit for capturing the flow rates of the fluid at the first locations in the supply network, as measured by the first sensors;
a prediction unit for predicting a flow rate at the second location by the trained system based on values of the flow rates at the first locations, as captured by the first capture unit;
a second capture unit for capturing an actual flow rate of the fluid at the second location by the second sensor at the second location;
a determination unit for determining a difference between the actual flow rate measured at the second location and the flow rate at the second location predicted by the trained system; and
an output unit for outputting a message of a suspected leak when the determined difference is greater than a predefined limit value.

14. An arrangement comprising:
a supply network having:
pipes configured for having a fluid flow through the pipes;
first sensors for measuring flow rates of a fluid at first locations in the supply network; and
at least one second sensor for measuring a flow rate of the fluid at a second location in the supply network; and
an apparatus for detecting a leak of the fluid, the apparatus comprising:
a self-learning system trained to predict a flow rate at a predefined location in the supply network;
a first capture unit for capturing the flow rates of the fluid at the first locations in the supply network, as measured by the first sensors;
a prediction unit for predicting a flow rate at the second location by the trained system based on values of the flow rates at the first locations, as captured by the first capture unit;
a second capture unit for capturing the flow rate of the fluid at the second location by the second sensor at the second location;
a determination unit for determining a difference between the flow rate measured at the second location and the flow rate at the second location predicted by the trained system; and
an output unit for outputting a message of a suspected leak when the determined difference is greater than a predefined limit value.

15. The method as claimed in of claim 9, wherein the series expansion is a principal component analysis.
